(19) United States
(12) Patent Application Publication
(10) Pub. No.: US 2019/0053506 A1
(43) Pub. Date: Feb. 21, 2019

(54) GAME DRESSING SYSTEM

(71) Applicant: JACKIE DURWARD BROCK, BASEHOR, KS (US)

(72) Inventor: JACKIE DURWARD BROCK, BASEHOR, KS (US)

(21) Appl. No.: 15/294,565

(22) Filed: Oct. 14, 2016

Related U.S. Application Data
(60) Provisional application No. 62/241,668, filed on Oct. 14, 2015.

(51) Int. Cl. A22C 21/00; A22C 21/06

(52) U.S. Cl. CPC A22C 21/0046; A22C 21/06

(57) ABSTRACT

A game dressing system for a bird includes a vertical tube, rotatably coupled to a hitch tube with a support gusset. A dressing rod is attached to the vertical tube and adapted to receive the bird. A carrying handle is attached to the vertical tube. Folding the vertical tube against the hitch tube enables a user to carry the game dressing system by the carrying handle.

### BACKGROUND OF THE INVENTION

### A. Field of the Invention

The present invention relates generally to animal husbandry. More specifically, the present invention provides improved devices and methods for field dressing a bird.

### B. Description of the Related Art

It is common for hunters to field dress game, especially game birds, shortly after collecting the animal carcasses in order to reduce spoilage, damage to the meat, and for ease of transport. Some hunters prefer to keep only the most desirable portions, such as the breast region of a bird, for human consumption.

Field dressing typically involves game shears, scissors, knives, or other sharp dressing tools. Dressing a bird or other game with a hunting knife or other tool can be dangerous, especially if the instrument or tool does not help hold a carcass in place to reduce slippage. Even if the instrument or tool helps hold the carcass in place, these instruments require both dexterity and strength to operate. Both dexterity and strength can be taxed when multiple carcasses are being dressed. In addition, many instruments and tools do not allow a user to dress game at an optimal speed, especially when dressing multiple carcasses.

### SUMMARY OF THE INVENTION

Prior to the disclosed invention, manually field dressing game birds was time consuming and messy. The disclosed invention provides a solution to these problems. In addition, the disclosed invention requires less dexterity and strength than current conventional means, which is particularly advantageous when more than one bird is being dressed.

A game dressing system for a bird includes a vertical tube, rotatably coupled to a hitch tube having a support gusset, and a dressing rod attached to the vertical tube such that when the vertical tube is placed in the operating position the dressing rod is located away from (i.e. distal) the area where the vertical tube is coupled to the hitch tube.

The dressing rod has a near end that is attached to the vertical tube and a far end adapted to receive a carcass. Preferably, the far end of the dressing rod is sharpened at an angle to improve the ease of inserting it into a carcass. Exemplary angles are 20°, 30°, 35°, 40°, 45°, 50°, 55°, 60°, and 70°. Preferably, the far end of the dressing rod is at about a 45° angle. Those of skill in the art will recognize that other angles can be used and even a flattened end could function in the invention.

The dressing rod is bent at about 90 degrees such that the far end of the dressing rod is relatively parallel to the vertical tube. While the dressing rod may be bent anywhere between its near and far ends, it is preferred that the dressing rod is bent such that a user can easily insert a variety of sized carcasses over the far end of the dressing rod when operating the invention.

The dressing rod can be made from a variety of materials including steel, other metals, wood, resins, plastics, or combinations thereof. A ½ inch steel dressing rod is a preferred rod for dressing a pheasant. Those of skill in the art will appreciate that a larger diameter rod would be more effective for larger birds such as a duck or goose. Similarly, a narrower diameter rod would be more suitable for smaller birds.

In some embodiments of the invention the dressing rod is attached to the vertical tube by welding the dressing rod into a permanent position. In other embodiments, the dressing rod is attached to the vertical tube by one or more suitable fasteners such that the dressing rod can be removed from the vertical tube. In embodiments where the dressing rod is removable, the vertical hitch rod can include multiple attachments positions for the dressing rod so that different users can adjust the position of the dressing rod to their preferred position(s) on the vertical hitch rod.

A carrying handle is also attached to the vertical tube. Folding the vertical tube against the hitch tube enables a user to carry the game dressing system by the carrying handle. Those of skill in the art will recognize that alternatively the carrying handle can be attached to the hitch tube. Such alternative arrangements are within the scope of the present invention.

A cap covers, and can be permanently attached, the far end of the vertical tube. The cap can be made of rubber, plastics, metal, various alloys, wood, fabric, or any combination thereof. Those of skill in the art will appreciate that any number of materials can be used to function as a cap. Using a cap to cover the exposed end of the vertical tube helps to reduce the introduction of moisture or other materials inside the vertical tube either during operation or transport.

In some embodiments the near end of the vertical tube is rotatably coupled to the near end of the hitch tube. In other embodiments that vertical tube and the hitch tube are rotatably coupled near their respective mid-points. In all preferred embodiments, the vertical tube is rotatably coupled to the hitch tube so that the vertical tube can fold horizontally and unfold vertically relative to the hitch tube.

Those of skill in the art will recognize that the vertical tube can be rotatably coupled to the hitch tube with any suitable fastener. Suitable fasteners include bolts, nuts, nails, and pins. A preferred fastener is a pivot bolt.

Certain embodiments of the invention include a swivel plate. A swivel plate can be attached to the vertical tube, or preferably, to the hitch tube. A variety of swivel plates are known in the art and can be interchangeably used in the invention. Suitable swivel plates allow a user to more easily move the vertical tube from the folded position (stored) to the unfolded position (operating). For example, one or more washers can be used to form a suitable swivel plate.

In preferred embodiments of the invention the hitch tube includes a hole on each lateral side near its far end (i.e. the end farthest from the support gusset) such that a hitch pin can be inserted through the hitch tube. In such embodiments the hitch tube can insert into a receiver hitch. It is envisioned that a user will prefer to use the invention in the field where a vehicle is the most convenient location to operate the invention. Nevertheless, those of skill in the art will recognize that the invention could be attached to a variety of other objects and still function as described.

Both the hitch tube and vertical tube can be a variety of lengths. For example, taller users may prefer a longer vertical tube. Similarly, longer hitch tubes may be preferred for attachment to some vehicles. In particular, a longer hitch tube is preferred when a user wants to lower the tailgate of a truck to use as an additional work surface while operating the invention.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a side view of one embodiment of the invention in the unfolded position.

FIG. 1B is a side view of the same embodiment of the invention in the folded position.

FIG. 2A is a side view of an assembled vertical tube. FIG. 2B is a side view of an unassembled vertical tube.

FIG. 3A is a side view of an assembled hitch tube. FIG. 2B is a side view of an unassembled hitch tube.

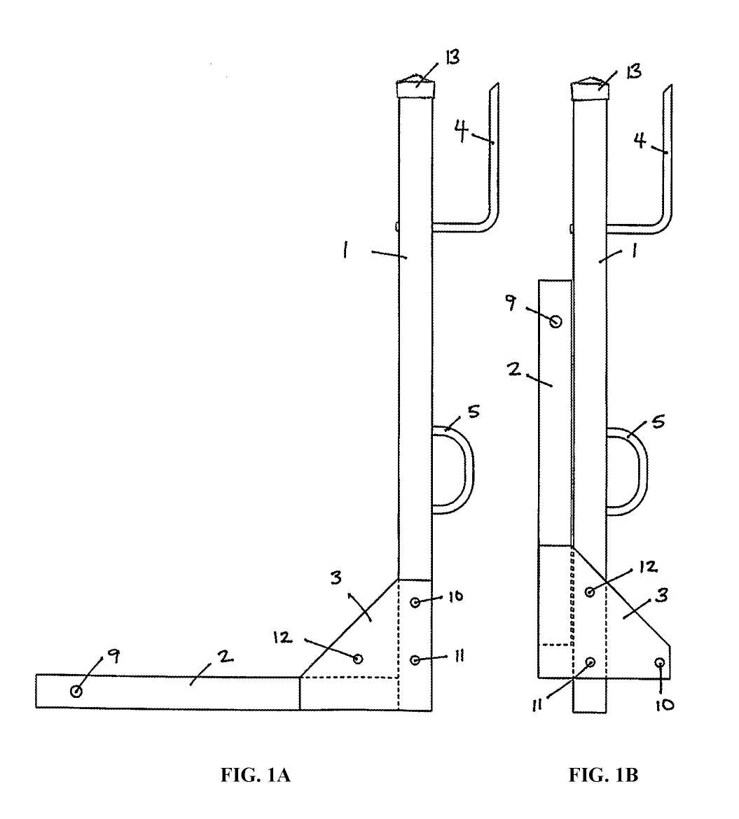

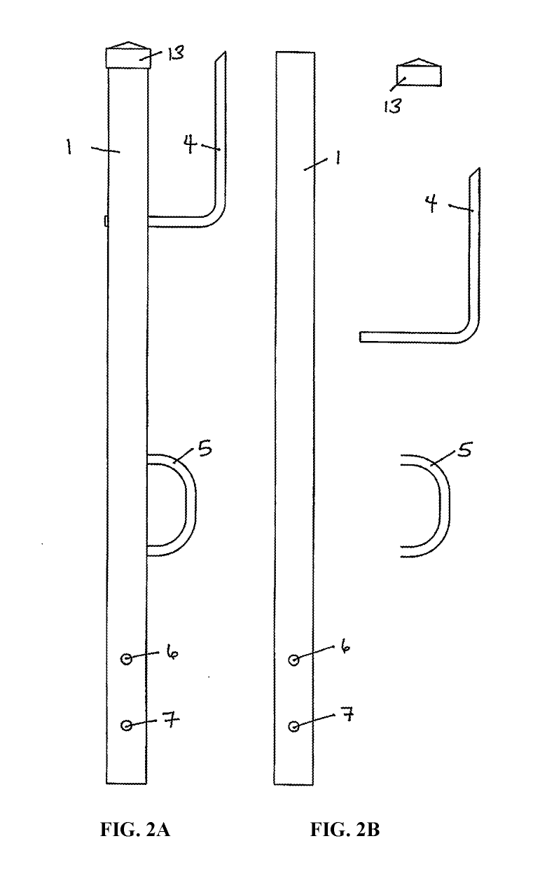

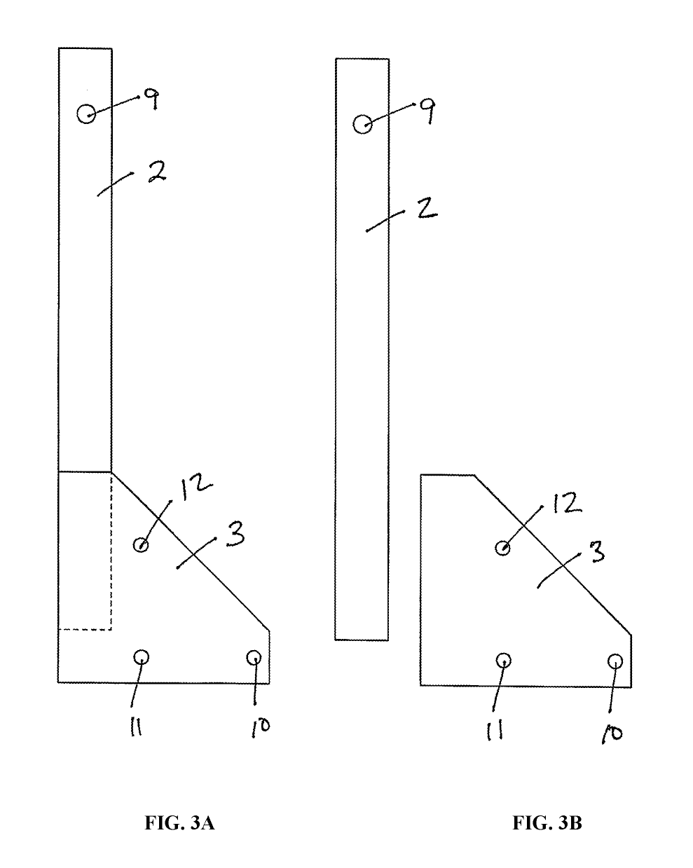

### DETAILED DESCRIPTION

By way of example, one embodiment of the present system comprises a vertical tube 1, rotatably coupled to a hitch tube 2 with a support gusset 3. A dressing rod 4 is attached to the vertical tube 1 and adapted to receive a bird. A carrying handle 5 is attached to the vertical tube 1. Folding the vertical tube 1 against the hitch tube 2 enables a user to carry the game dressing system by the carrying handle 5.

In the embodiment shown in the figures and when viewed laterally, the vertical tube 1 and hitch tube 2 are parallelograms and substantially rectangular in shape. Preferably, both tubes are generally hollow and open at each end. When viewed from either end, both tubes are parallelograms and roughly rectangular, preferably square, in shape. Those of skill in the art will understand that either tube can have a different shape. For example, either or both tubes may be a parallelepiped or cylindrical in shape as long as the tubes can be assembled to form the disclosed system.

Turning to these components in more detail, the vertical tube 1 can be rotatably coupled to the hitch tube 2 with a pivot bolt 14 with an additional (support) bolt 15 used to hold the vertical and horizontal tubes 1, 2 in a folded (for transport) or unfolded (for operation) position. Pivot bolt 14 extends through both hole 7 in the vertical tube 1 and hole 11 in support gusset 3. When the vertical tube 1 is placed in the operating position, the support bolt 15 extends through both hole 6 in the vertical tube 1 and hole 10 in support gusset 3 to hold the vertical tube 1 in a stationary position relative to the hitch tube 2. When the vertical tube 1 is placed in the folded position, the support bolt 15 extends through both hole 6 in the vertical tube 1 and hole 12 in support gusset 3 to hold the vertical tube 1 in the folded position.

Each bolt can be secured through any suitable means such as a wing nut or other type of threaded fastener and with or without a washer(s). Those of skill in the art will recognize that other types of suitable fasteners can be substituted for pivot bolt 14 and support bolt 15 and achieve similar results.

In some embodiments it is desirable to include a swivel plate 16, preferably welded to the hitch tube 2 but alternatively welded to vertical tube 1, to improve a user's ease of changing the system from the stowed (folded) position to the operating position. (The swivel plate 16 is not shown in the embodiment presented in the figures.) Those of skill of art will recognize that while welding is a preferred means of attaching the swivel plate to a tube, a swivel plate can be attached to either tube by any number of suitable means as long as the chosen means allows the vertical tube 1 to be raised to the operating position and lowered to the folded position.

In the unfolded position, the hitch tube 2 can be attached to a vehicle's receiver hitch with a pin—a ⅝ inch pin is suitable for most commonly used receiver hitches—that is inserted through holes 9 in the hitch tube 2 and the vehicle's receiver hitch. Those of skill in the art will recognize that other sized pins or means can be suitable for attaching the invention to a receiver hitch as long as the means can secure the invention to the vehicle, preferably at the vehicle's hitch. A hole 9 is present on both lateral sides of the hitch tube 2.

To use the invention, prepare a bird, such as a pheasant, duck, goose, or grouse, by removing the feathers on the breast. Next, with the bird in an upright orientation insert an end point of the dressing rod 4 into the bird below and behind the bottom of the breast (above the abdomen) up the back of the breast and out of the bird between the breast and neck. Next, a user can grasp the neck of the bird and pull downward and away from the dressing rod 4 separating the breast from the remainder of the bird. Alternatively, a user can insert one or more fingers between the breast and the dressing rod 4 and pull downward and away from the dressing rod 4 to separate the breast from the remainder of the bird.

Alternatively, a bird can be placed on the dressing rod 4 in an upside down position. The end point of dressing rod 4 is inserted between the breast and the neck and extends through the bird and behind the breast to the bottom of the breast and out of the bird between the breast and abdomen. A user can then grasp the feet and tail and pull away and downward to remove the breast from the bird. The breast meat can now be cleaned. Depending upon the applicable regional rules and laws, at least one wing, and optionally the head, can remain attached to the breast for identification during transport.

In some embodiments, the vertical tube 1 and the hitch tube 2 can be made from two inch by two inch square tube cut to two different lengths. Of course, those of skill in the art will appreciate that other sizes can be used. The preferred sizes depend in part upon the type of vehicle receiver hitch, desired weight, and the user's own preferences.

In a preferred embodiment, the shorter hitch tube 2 fits into a receiver hitch and has one 11/16 inch hole 9 on each lateral side for the hitch pin to secure the shorter hitch tube 2 to the vehicle. The shorter hitch tube 2 can further comprise a 3/16 inch swivel plate 16 welded to the hitch tube 2 to help secure the vertical tube 1 and the hitch tube 2 in the stowed and operating positions.

In a preferred embodiment, the longer vertical tube 1 has three 17/32 inch holes bored through the tube. Two of the holes 6 and 7 are for the pivoting and securing, respectively, of the invention into position. The third hole 16 (not shown) is to receive the dressing rod 4. Alternatively, the vertical tube 1 can include multiple third holes 16 such that the position of the dressing rod 4 on the vertical tube 1 can be adjusted as desired.

The dressing rod 4 can be made from a ½ inch steel round rod that is bent 90° with an end point such as 45° or other angle that provides a suitably sharp point on which to place a bird. Those of skill in the art will recognize that the dressing rod 4 can be made from a variety of other materials include other metals, wood, resins, plastics, or combinations thereof. A ½ inch steel rod is a preferred size for a dressing rod 4 for dressing a pheasant. Those of skill in the art will appreciate that a larger diameter rod would be more effective for larger birds such as a duck or goose. Similarly, a narrower diameter rod would be more suitable for smaller birds.

The other end of the dressing rod 4 is attached, preferably by insertion through hole 16 and either by welding or by the use of a suitable fastener(s), to the longer vertical tube 1. Suitable fasteners include nuts, wing nuts, bolts, washers, or combinations thereof. Preferably, a ½ inch steel round rod handle 5 is welded to the longer tube to carry the invention in the stowed position. Those of skill in the art will appreciate that the handle 5 can be made of a variety of materials other than steel and attached to the vertical tube 1.

Unless defined otherwise, all technical and scientific terms used herein have the same meaning as is commonly understood by one of skill in the art to which this invention belongs at the time of filing. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular. Herein, the use of “or” means “and/or” unless stated otherwise. Furthermore, the use of the term “including”, as well as other forms such as “includes” and “included” is not limiting.

It is also to be understood that the terminology used herein is for the purpose of describing particular embodiments of the invention only, and is not intended to be limiting. It must be noted that, as used in this specification and the appended claims, the singular forms “a”, “an” and “the” include plural referents unless the content clearly dictates otherwise.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the following claims.

What is claimed is:

1. A game dressing system comprising:
a) a vertical tube;
b) a hitch tube with a support gusset; and
c) a dressing rod having a near end attached to the vertical tube and a far end adapted to receive a carcass,
wherein a near end of the vertical tube is rotatably coupled to a near end of the hitch tube such that the vertical tube can fold horizontally and unfold vertically relative to the hitch tube.

2. The game dressing system of claim 1 further comprising a carrying handle.

3. The game dressing system of claim 2, wherein the carrying handle is attached to the vertical tube.

4. The game dressing system of claim 2, wherein the carrying handle is attached to the hitch tube.

5. The game dressing system of claim 1 further comprising a fastener, wherein the fastener attaches the vertical tube to the hitch tube.

6. The game dressing system of claim 5, wherein the fastener is a pivot bolt.

7. The game dressing system of claim 1 further comprising a swivel plate attached to the vertical tube or the hitch tube.

8. The game dressing system of claim 1, wherein the distal end of the dressing rod is sharpened.

9. The game dressing system of claim 1, wherein the dressing rod is bent about 90 degrees such that the distal end of the dressing rod is relatively parallel to the vertical tube.

10. The game dressing system of claim 1, wherein the hitch tube includes a hole on each lateral side near its distal end such that a hitch pin can be inserted through the hitch tube.

11. The game dressing system of claim 10, wherein the hitch tube can insert into a receiver hitch.

12. The game dressing system of claim 1 further comprising a cap that covers the far end of the vertical tube.
